(19) United States
(12) Patent Application Publication
(10) Pub. No.: US 2014/0164778 A1
(43) Pub. Date: Jun. 12, 2014

(54) Method for producing and storage of digital certificates

(71) Applicants: Andrei Yoryevich Sherbakov, Moscow (RU); Oleg Olegovich Tikhonenko, Moscow (RU)

(72) Inventors: Andrei Yoryevich Sherbakov, Moscow (RU); Oleg Olegovich Tikhonenko, Moscow (RU)

(21) Appl. No.: 13/707,962

(22) Filed: Dec. 7, 2012

(51) Int. Cl. H04L 9/32

(52) U.S. Cl. CPC H04L 9/3247
USPC 713/175

(57) ABSTRACT

The proposed method relates to methods for obtaining, storage, and exchange of digital information, including replication and distribution of software, more specifically, to methods for producing and storage of digital certificates and replication of software therefor. The proposed method will find useful application for safe storage and transmitting various data, e.g. personal data, electronic funds, and, also for replication and distribution of software. Comparing with all known related art methods, the present method is characterized with an essentially increased level of protection of storage and transmission of digital information and replication of software due to affirmation of the digital certificate in authorized entities, due to the employment of consolidated certificates, as well as due to the enhancement of authenticity of information transmission with the use of electronic digital signatures.

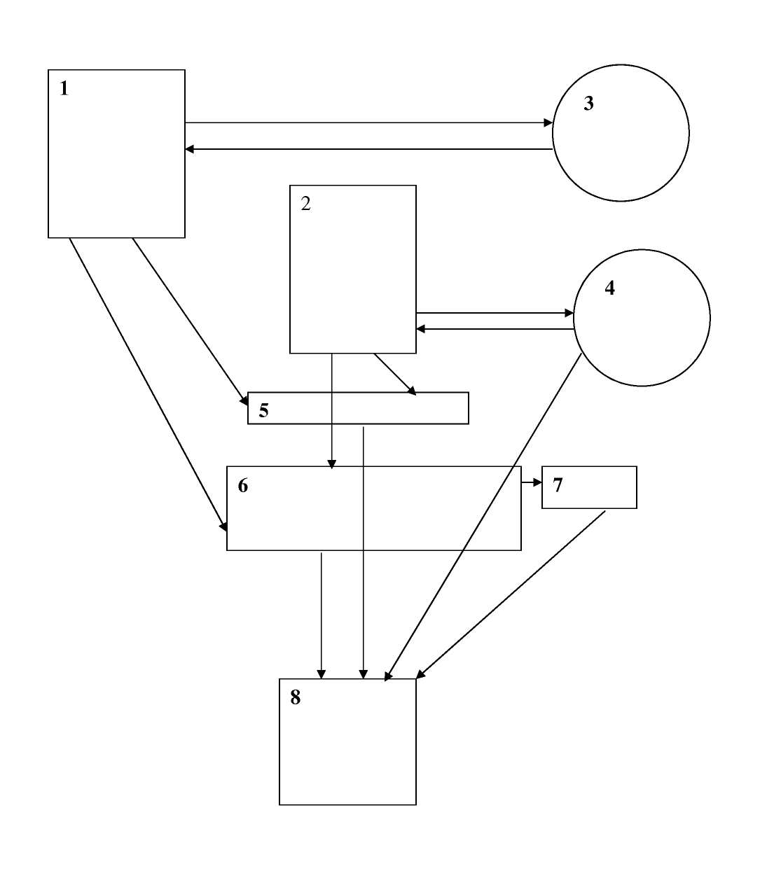

### CROSS REFERENCES TO RELATED APPLICATIONS

This U.S. patent application claims priority under 35 U.S.C. 119(a) through (d) from a EAPO application EA201200133 filed on 16 Feb. 2012, hereby entirely incorporated by reference.

### FIELD OF THE INVENTION

The present invention relates to methods for obtaining, storage, and exchange of digital information, including replication and distribution of software, more specifically, to methods for producing and storage of digital certificates and replication of software therefor. The present invention can find useful applications for safe storage and transmission of data (e.g. personal data, electronic monetary funds, etc.), and software.

### BACKGROUND OF THE INVENTION

Nowadays, electronic signatures and digital certificates are used for safe transmission of digital information. The closest related art to this invention is considered “Method and device for obtaining and storage of a personal certificate and method for safe exchange of information” disclosed in Euro-Asian Patent 008186, herein further called a ‘prototype’ having the following features:

a digital certificate, including an electronic digital signature, is received from an authorization entity and transferred into a memory unit for long term storage;

a personal closed key is transferred from a generator of random numbers into the memory unit for long term storage;

the personal closed key stored in the memory unit is transferred into a processing unit;

the processing unit converts the personal closed key into a personal public key;

the personal public key is transferred from the processing unit to the authorization entity;

in the authorization entity, the personal public key is transformed into a personal digital certificate, containing an electronic digital signature;

the personal digital certificate is transferred into the memory unit for long term storage.

However, the aforementioned method has a number of shortcomings, such as:

it does not take into account a case when several authorization entities exist, they all have equal rights (e.g. international), or a hierarchical structure of authorization entities exists, wherein a superior entity delegates its functions, or a part thereof, to a subordinate entity;

it does not solve a critical problem of replication of software, when a software producer commits a broker or a few brokers to replicate software produced by the software producer with observation of the producer's intellectual and other property rights.

For overcoming the mentioned shortcomings, two variants of a method for obtaining and storage of digital certificates and a method for replication of software are herein disclosed.

### BRIEF SUMMARY OF THE INVENTION

A method for obtaining and storage of digital certificates comprises the steps of:

forming a consolidated digital certificate including at least two public keys of authorization entities, wherein the public keys are signed with electronic signatures, and placing the consolidated digital certificate in a first memory unit for storage;

generating a personal closed key by a random number generator, and placing the personal closed key into a second memory unit;

converting the personal closed key, stored in the second memory unit, into a personal public key;

transferring the personal public key to the authorized entity;

forming a personal digital certificate from the personal public key in the authorized entity, wherein the personal digital certificate contains the electronic digital signature of the personal public key, and a necessary additional information on the owner of the personal digital certificate;

transferring the digital certificate into the first memory unit for storage;

if necessary, joining two or more personal digital certificates in one consolidated personal digital certificate;

authenticity control of the personal digital certificate or consolidated personal digital certificate before using thereof by checking the electronic signature(s) thereof utilizing sequential and independent inspections of all digital signatures contained in the consolidated digital certificate.

The first method for replication of software includes checking a digital signature using the personal certificate of producer and/or of distributor of the software, produced according the method.

The second method for replication of software includes a step of coding the software by a personal public key of a user before shipping to the user.

Coding of digital information is a conversion of initial (public) text of digital communications (in this case, executable code of software) such as the meaning of text becomes not understood for any person not possessing a secret key of reverse conversion.

An electronic digital signature is digital information addable to a block of data (data block) obtained as a result of a cryptographic conversion depending upon a secret key and the data block, which data allow a receptor of the data to verify the integrity of the data block and the authenticity of a source of the data, as well as to provide protection against a forgery on the part of the receptor of data.

Control of the electronic digital signature (EDS) placed under a block of public information is carried out with the help of cryptographic conversion and an public key, corresponding to the secret key that took part in the process of establishing the EDS.

### BRIEF DESCRIPTION OF DRAWING

FIGURE attached hereto is a flowchart that illustrates the inventive method for producing and storage of digital certificates.

### DETAIL DESCRIPTION OF PREFERRED EMBODIMENTS OF THE INVENTION

While the invention may be susceptible to embodiment in different forms, there are described in detail herein below, specific embodiments of the present invention, with the understanding that the present disclosure is to be considered an exemplification of the principles of the invention, and is not intended to limit the invention to that as illustrated and described herein.

For an exemplary demonstration of the invention, FIGURE attached hereto illustrates the inventive method for producing and storage of digital certificates. A system for implementation of the inventive method comprises: a software producer 1, a software distributor 2, an authorized entity 3, an authorized entity 4, a consolidated personal digital certificate 5, software 6, its digital signature 7, and a user 8 of the software.

The system operates as follows:

the consolidated certificate 5, containing at least two public keys with electronic digital signatures of the authorized entities 3 and 4, is placed in a memory unit of the producer 1 and distributor 2 for storage; then personal closed keys for the producer 1 and distributor 2 are obtained from a random number generator, the personal closed keys are placed into the memory unit for storage;

then the closed keys are converted into a personal public key of producer 1 and a personal public key of distributor 2;

thereafter, the personal public key of producer 1 and distributor 2 are forwarded to the authorized entities 3 and 4, wherein digital certificates of producer 1 and distributor 2 are formed, which digital certificates contain an electronic digital signature of the personal public key and necessary additional information about the owner of the personal digital certificate, in particular, a purpose of the certificate for distribution of software; then the two personal digital certificates are joined into the consolidated personal digital certificate 5.

Software 6 is signed by the digital signature of producer 1 and distributor 2 with the use of their personal closed keys simultaneously, or separately, resulting in formation of the digital signature 7; thereafter software 6 and the digital signature 7 are passed to the user 8, who gets a consolidated personal digital certificate from any of the authorized entities (e.g. entity 4), which consolidated personal digital certificate is checked for authenticity by checking up its electronic digital signature(s) employing a sequential or independent inspection of all the digital signatures contained in the consolidated digital certificate; and based thereon, the consolidated digital certificates 5 of producer 1 and distributor 2 are checked, then before installation of software 6, the user 8 checks on the digital signature 7.

Besides, the instant inventors foresee great prospective in the use of the present invention for storage and exchange of digital objects of intellectual property (e.g. music or video files) and digitized documents, verifying the right to property, as well as for using in payment systems and accounting systems with employment virtual and electronic monetary funds.

Comparatively with all invention known to the instant inventors, the present invention is characterized with an essentially higher level of protection and transmission of digital information and replication of software due to—verification of the digital certificate in several authorized entities;—using consolidated certificates; and—utilization of an electronic digital signature.

We claim:

1. A method for producing and storage of digital certificates comprising the steps of:
providing a consolidated digital certificate including at least two public keys pertaining to an authorized entity;
signing said consolidated digital certificate with an electronic digital signature;
placing the consolidated digital certificate into a first memory unit for storage;
obtaining a personal closed key from a random number generator;
placing said personal closed key into a second memory unit;
converting the personal closed key into a personal public key;
forwarding the personal public key to the authorized entity;
forming at least one personal digital certificate by the authorized entity, based on the personal public key; said at least one personal digital certificate is assigned to an owner; said at least one personal digital certificate includes an electronic digital signature for the personal public key, and predetermined additional information on said owner; and
transferring said at least one personal digital certificate into the first memory unit for storage.

2. The method for producing and storage of a digital certificate according to claim 1, wherein said at least one personal digital certificate is represented by at least two personal digital certificates; said method further comprises the steps of:
said at least two personal digital certificates are joined into a consolidated personal digital certificate; and
before deployment, checking for authenticity said at least two personal digital certificates and the consolidated personal digital certificate by controlling the electronic digital signature thereof with the use of a sequential or independent inspection of the digital signatures contained in the consolidated digital certificate.
